(19) United States
(12) Patent Application Publication
(10) Pub. No.: US 2025/0103220 A1
(43) Pub. Date: Mar. 27, 2025

(54) ENABLING POWER OPTIMIZATION THROUGH DRAM BANK MANAGEMENT IN SOLID STATE DRIVES

(71) Applicant: WESTERN DIGITAL TECHNOLOGIES, INC., San Jose, CA (US)

(72) Inventors: RAMANATHAN MUTHIAH, Bangalore (IN); JUDAH GAMLIEL HAHN, Bangalore (IN)

(73) Assignee: WESTERN DIGITAL TECHNOLOGIES, INC., San Jose, CA (US)

(21) Appl. No.: 18/373,403

(22) Filed: Sep. 27, 2023

(51) Int. Cl. G06F 3/06

(52) U.S. Cl. CPC G06F 3/0625; G06F 3/0634; G06F 3/0673

(57) ABSTRACT

A storage device optimizes performance and operates under a predefined power ceiling. The storage device determines its power usage and when the power usage is below a power ceiling threshold, the storage device operates according to a first random-access memory (RAM) usage policy and uses an internal RAM in processing host data. When the power usage is above the power ceiling threshold, the storage device operates according to a second RAM usage policy and uses an external RAM or the external RAM and portions of the internal RAM in processing the host data. The storage device switches to the first RAM usage policy when it determines that the host device is operating in a high-performance mode, there is a drop in cache hits on the external RAM, or a congestion level on a link between the host device and the storage device is above a congestion threshold.

### BACKGROUND

A storage device may be communicatively coupled to a host and may receive data from the host for storage on a non-volatile memory. The memory may be, for example, a flash memory device that may also be communicatively coupled to the storage device. In processing data on the storage device, a controller on the storage device may access volatile memory located on the storage device. For example, the controller may access a static random-access memory (SRAM) located on the same chip as the controller or the controller may access a dynamic random-access memory (DRAM) located on another chip in the storage device via a DRAM interface. The SRAM and DRAM may be used as caches to store data structures and/or as buffers in a read/write path or when manipulating data such as a flash translation table.

The controller may also access a host memory buffer (HMB), i.e., a cache provided by the host to improve the performance of the storage device. The size of the HMB may be limited to, for example, 64 megabytes (MB), whereas the size of the DRAM may be multiple times larger than the size of the HMB. So, unlike the DRAM that the controller may use to temporarily store large amounts of data such as the flash translation table, the controller may use the HMB as a cache to store a relatively limited amounts of data. When the controller uses the HMB instead of the DRAM to store information in the flash translation table, the controller may have to swap information in the flash translation table in and out of the HMB, which may result in cache misses and processing overhead on the storage device.

The storage device may have a ceiling on the amount of power it may consume. For example, in some storage devices, the power ceiling may be 5 watts (W) or 8 W. Although use of the DRAM may be necessary for the storage device to meet performance targets, power consumed by the DRAM may be attributed to the storage device as the DRAM is located in the storage device. The power ceiling under which the storage device may operate may therefore create a hurdle for the storage device in using the full capabilities of the DRAM. Unlike the DRAM, power consumed by the HMB is attributed to the host and does not add to the power consumption attributed to the storage device. To remain under the power ceiling, the controller may only be able to use portions of the DRAM and/or the HMB. However, as noted, the HMB is typically smaller than the DRAM and swapping data in and out of the HMB during use of the HMB may increase data access latency on the storage device. A system flow is therefore needed such that the storage device may optimize power consumption and performance.

### SUMMARY

In some implementations, the storage device optimizes performance and operates under a predefined power ceiling. The storage device includes a controller to receive an indication of a power mode under which the storage device is to operate from a host device. The storage device also includes a power optimization module to determine power usage by the storage device. When the power usage is below a power ceiling threshold, the power optimization module issues a first random-access memory (RAM) usage policy for the controller to use an internal RAM in processing host data. When the power usage is above the power ceiling threshold, the power optimization module issues a second RAM usage policy for the controller to use an external RAM or the external RAM and portions of the internal RAM in processing the host data.

In some implementations, one or more methods are provided for optimizing the performance on the storage device and operating under a predefined power ceiling. The methods include receiving an indication of a power mode under which the storage device is to operate from a host device and determining the power usage of the storage device. The methods also include issuing a first random-access memory (RAM) usage policy to use an internal RAM in processing host data when the power usage is below a power ceiling threshold and issuing a second RAM usage policy to use an external RAM or the external RAM and portions of the internal RAM in processing the host data when the power usage is above the power ceiling threshold. The method further includes when operating under second RAM usage policy, receiving a high-performance mode command from the host device, determining that the host device is operating in the high-performance mode, determining that there is a drop in cache hits on the external RAM, or determining that a congestion level on a link between the host device and the storage device is above a congestion threshold, and issuing the first RAM usage policy to use the internal RAM in processing host data

### BRIEF DESCRIPTION OF THE SEVERAL VIEWS OF THE DRAWINGS

FIG. 1 is a schematic block diagram of an example system in accordance with some implementations.

FIG. 2 is a flow diagram of an example process for a storage device to optimize performance and operate under a predefined power ceiling in accordance with some implementations.

FIG. 3 is a flow diagram of an example process for a storage device to improve performance by switching from an external cache to an internal cache in accordance with some implementations.

FIG. 4 is a diagram of an example environment in which systems and/or methods described herein are implemented.

FIG. 5 is a diagram of example components of the host of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

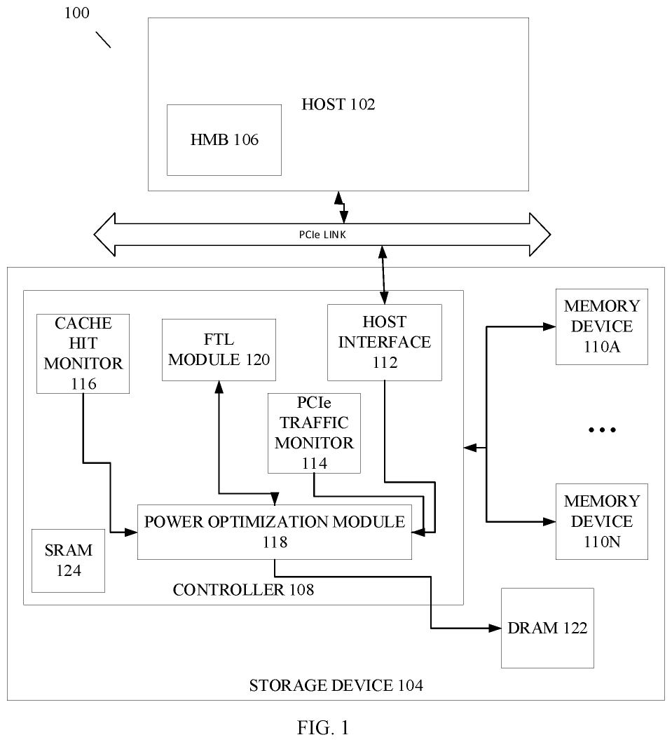

FIG. 1 is a schematic block diagram of an example system in accordance with some implementations. System 100 includes a host 102 and a storage device 104. Host 102 may transmit commands to read or write data to storage device 104. Host 102 may include a host memory buffer (HMB) 106 to cache, for example, mapping information used by storage device 104. Host 102 and storage device 104 may be in the same physical location as components on a single computing device or on different computing devices that are communicatively coupled. Storage device 104, in various implementations, may be disposed in one or more different locations relative to the host 102 and storage device 104 may communicate with host 102 over a peripheral component interconnect express (PCIe) protocol and the like. Host 102 may include additional components (not shown in this figure for the sake of simplicity).

Storage device 104 may include a controller 108, one or more memory devices 110a-110n (referred to herein as memory device(s) 110), a host interface 112, a PCIe traffic monitor 114, a cache hit monitor 116, a power optimization module 118, a flash translation layer (FTL) module 120, a DRAM 122 and a SRAM 124. Controller 108 may process foreground operations to read data from or write data to memory device 110 based on instructions received from host 102. Controller may also execute background operations to manage resources on memory device 110. For example, controller 108 may monitor memory device 110 and may execute garbage collection and other relocation functions per internal relocation algorithms to refresh and/or relocate the data on memory device 110.

Controller 108 may cache information needed to process foreground and/or background operations on DRAM 122 and/or SRAM 124. Memory device 110 may be flash based, including, for example, NAND flash memory. Memory device 110 may be included in storage device 104 or may be otherwise communicatively coupled to storage device 104.

Host 102 may supply power to storage device 104 and host 102 may indicate to storage device 104 which power mode or power state (PS) to operate under. For example, if a power ceiling for storage device 104 is 5 watts (W), and if 5 W is associated with a PS 2, host 102 may indicate to storage device 104 to operate under PS 2; or if a power ceiling for storage device 104 is 8 W, and if 8 W is associated with PS 1, host 102 may indicate to storage device 104 to operate under PS 1. Host 102 may also indicate that storage device 104 may operate under a high-performance mode which may be associated with, for example, PS 0. The high-performance mode may be set using a vendor unique host command, a Non-Volatile Memory Express (NVMe) workload hint, and/or the highest power state (PS 0). When storage device is operating under the high-performance mode, storage device 104 may disregard the power ceiling under which storage device 104 is to operate.

When host 102 sends a command to storage device 104, host interface 112 may receive the command and provide an indication of the host command to power optimization module 118. The command may be, for example, a read command, a write command, or a power mode command. When host 102 issues a read command, host 102 may send logical block address(es) associated with the data to be read from memory device 110. Controller 108 may access the data stored on memory device 110 by accessing a logical-to-physical (L2P) table including a mapping of the logical address(es) associated with data with physical address(es) on memory device 110. FTL module 120 may map the host generated logical block addresses to the physical addresses of memory device 110 and store the FTL mappings in a volatile random-access memory (RAM) (for example, DRAM 122) using a first RAM usage policy as defined by power optimization module 118. The first RAM usage policy may be issued when storage device 104 is operating under its power ceiling or a power ceiling threshold. The power ceiling threshold may be a predefined threshold that may be below the power ceiling under which storage device 104 is to operate. As FTL module 120 is processing backend storage operations while operating under the first in RAM usage policy, FTL module 120 may access the L2P table and other information cached in DRAM 122.

As the power used by DRAM 122 is attributed to storage device 104, to remain under the power ceiling under which storage device 104 is to operate, power optimization module 118 may track the power usage of storage device 104. When power optimization module 118 determines that power usage of storage device 104 is at or above the power ceiling threshold, power optimization module 118 may issue a second RAM usage policy to FTL module 120. The second RAM usage policy may be set to save on the power attributed to storage device 104 and/or to meet a power target. The second RAM usage policy may also be set to enable storage device 104 to use an external cache (for example, HMB 106) even if an internal cache (for example, DRAM 122) is available for use.

As part of the second RAM usage policy, power optimization module 118 may inform FTL module 120 to minimize or stop usage of DRAM 122 and to increase usage of HMB 106. For example, as part of the second RAM usage policy, power optimization module 118 may inform FTL module 120 to stop using DRAM 122 for a predefined period of time or until the power consumption on storage device 104 reaches a certain point. In another example, as part of the second RAM usage policy, power optimization module 118 may inform FTL module 120 to use HMB 106 and a portion of DRAM 122. As such, based on the second RAM usage policy, storage device 104 may switch off some banks in DRAM 122 and use the HMB 106 proportionately to meet a power target specification.

Based on instructions from power optimization module 118, FTL module 120 may load L2P mapping information in HMB 106 rather than in DRAM 122 or may load L2P mapping information in HMB 106 and in portions of DRAM 122. The use of HMB 106 may result in higher latency than may be experienced when using DRAM 122. Thus, there may be a performance impact (especially at very low queue depth) when FTL module 120 switches to HMB 106. In some implementations, partial use of DRAM 122 may continue for commands with a higher hit count, with HMB 106 as a secondary cache. In thermal throttling conditions, where performance is meant to be restricted, DRAM 122 may be turned off entirely and storage device 104 may switch to HMB 106.

As the size of HMB 106 may be relatively smaller than that of DRAM 122. FTL module 120 may load relatively fewer L2P table pages in HMB 106 and FTL module 120 may have to swap L2P table pages in and out of HMB 106 to process backend storage operations. As such, when HMB 106 is being used, the input/output traffic between host 102 and storage device 104 may increase. PCIe traffic monitor 114 may monitor the traffic between host 102 and storage device 104 and provide updates on the traffic flow to power optimization module 118. Power optimization module 118 may use information provided by PCIe traffic monitor 114 to monitor the congestion level on the PCIe link between host 102 and storage device 104.

If FTL module 120 is processing a large volume of requests, the information cached in HMB 106 may not be the information needed by FTL module 120 and FTL module 120 may have to swap out the information stored in HMB 106 and replace it with the information needed by FTL module 120. This swapping in and out of cached information may result in a drop in cache hits by FTL module 120. As FTL module 120 swaps mapping information cached in HMB 106, use of HMB 106 may increase the overhead on storage device 104. Cache hit monitor 116 may track how many pages are swapped in and out of HMB 106 and provide an indication of the swap in/swap out rate to power optimization module 118. Power optimization module 118 may use information provided by cache hit monitor 116 to monitor the swap in/swap out rate on HMB 106.

As storage device 104 uses HMB 106, power optimization module 118 may also determine if host 102 is operating in a high-performance mode. Power optimization module 118 may determine that host 102 is operating in the high-performance mode either from a host command received by host interface 112 or from an internal mechanism on storage device 104. For example, the internal mechanism may determine that the commands being issued by host 102 are associated with the high-performance mode and may provide an indication to power optimization module 118 that host 102 is operating in the high-performance mode. When power optimization module 118 determines that host 102 is operating in the high-performance mode, power optimization module 118 may disregard the power ceiling and issue the first RAM usage policy. As such, in the high-performance mode, storage device 104 may operate according to the first RAM usage policy.

If storage device 104 receives a high-performance mode command from host 102 or otherwise determines that host 102 is operating in the high-performance mode, that there is a drop in cache hits based on information received from cache hit monitor 116, or that the congestion on the PCIe link is above a congestion threshold, power optimization module 118 may issue the first RAM usage policy to instruct FTL module 120 to use DRAM 122. This may enable storage device 104 to selectively enable or disable the internal DRAM interface. For example, storage device 104 may selectively enable the internal DRAM interface when in the high-performance mode and may selectively disable the internal DRAM interface when host 102 is not operating in the high-performance mode. In another example, storage device 104 may selectively enable or disable DRAM 122 usage based on cache hits and/or PCIe traffic congestion. Storage device 104 may thus use HMB 106, for example, during non-peak loads, when it determines that FTL module 120 is accessing a narrow range of data requests, or when the PCIe traffic is such that HMB 106 access does not congest the PCIe traffic lanes.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

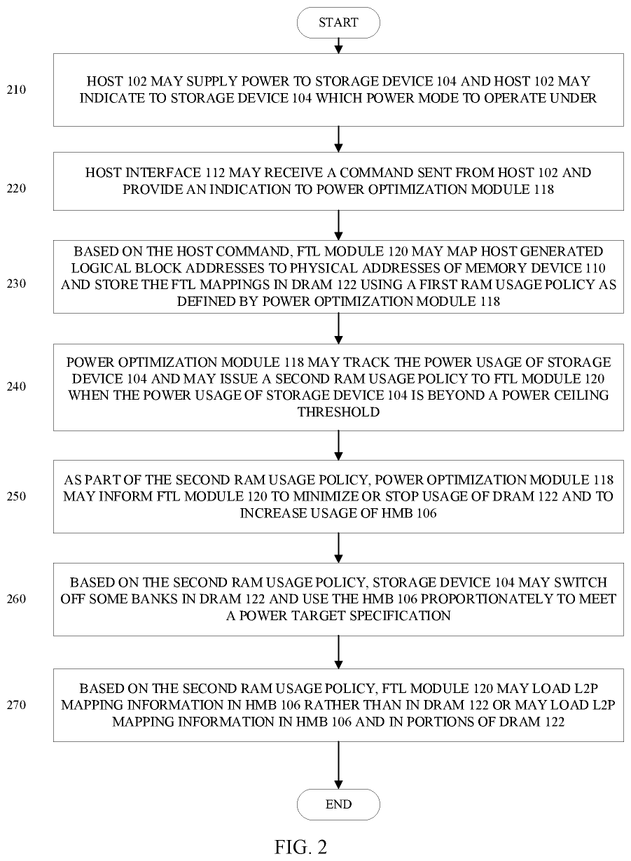

FIG. 2 is a flow diagram of an example process for a storage device to optimize performance and operate under a predefined power ceiling in accordance with some implementations. At 210, host 102 may supply power to storage device 104 and host 102 may indicate to storage device 104 which power mode to operate under. At 220, host interface 112 may receive a command sent from host 102 and provide an indication to power optimization module 118. At 230, based on the host command, FTL module 120 may map host generated logical block addresses to physical addresses of memory device 110 and store the FTL mappings in DRAM 122 using a first RAM usage policy as defined by power optimization module 118.

At 240, power optimization module 118 may track the power usage of storage device 104 and may issue a second RAM usage policy to FTL module 120 when the power usage of storage device 104 is beyond a power ceiling threshold. At 250, as part of the second RAM usage policy, power optimization module 118 may inform FTL module 120 to minimize or stop usage of DRAM 122 and to increase usage of HMB 106. At 260, based on the second RAM usage policy, storage device 104 may switch off some banks in DRAM 122 and use the HMB 106 proportionately to meet a power target specification. At 270, based on the second RAM usage policy, FTL module 120 may load L2P mapping information in HMB 106 rather than in DRAM 122 or may load L2P mapping information in HMB 106 and in portions of DRAM 122. FIG. 2 is provided as an example. Other examples may differ from what is described in FIG. 2.

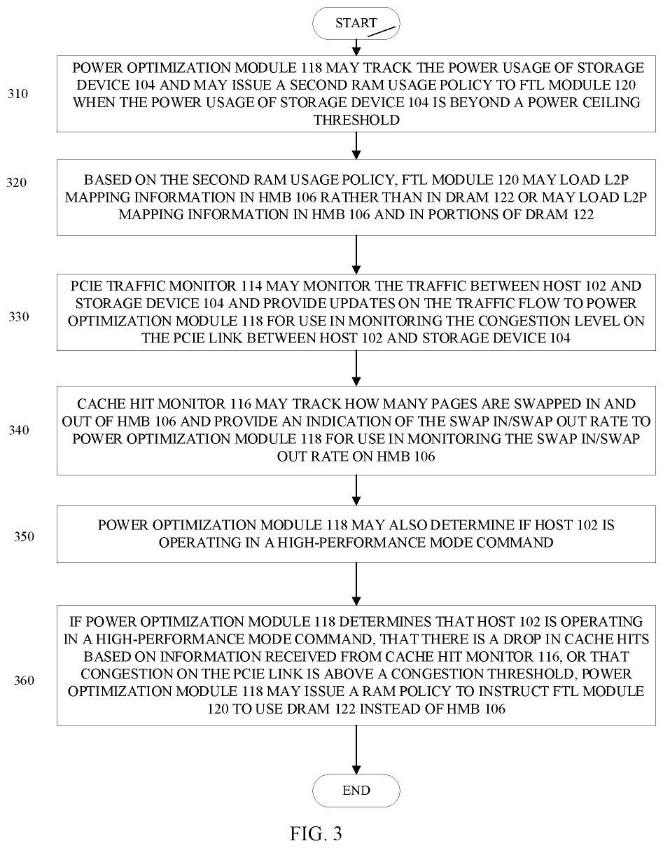

FIG. 3 is a flow diagram of an example process for a storage device to improve performance by switching from an external cache to an internal cache in accordance with some implementations. At 310, power optimization module 118 may track the power usage of storage device 104 and may issue a second RAM usage policy to FTL module 120 when the power usage of storage device 104 is beyond a power ceiling threshold. At 320, based on the second RAM usage policy, FTL module 120 may load L2P mapping information in HMB 106 rather than in DRAM 122 or may load L2P mapping information in HMB 106 and in portions of DRAM 122.

At 330, PCIe traffic monitor 114 may monitor the traffic between host 102 and storage device 104 and provide updates on the traffic flow to power optimization module 118 for use in monitoring the congestion level on the PCIe link between host 102 and storage device 104. At 340, cache hit monitor 116 may track how many pages are swapped in and out of HMB 106 and provide an indication of the swap in/swap out rate to power optimization module 118 for use in monitoring the swap in/swap out rate on HMB 106. At 350, power optimization module 118 may also determine if host 102 is operating in a high-performance mode command. At 360, if power optimization module 118 determines that host 102 is operating in a high-performance mode command, that there is a drop in cache hits based on information received from cache hit monitor 116, or that congestion on the PCIe link is above a congestion threshold, power optimization module 118 may issue a RAM policy to instruct FTL module 120 to use DRAM 122 instead of HMB 106. As indicated above FIG. 3 is provided as an example. Other examples may differ from what is described in FIG. 3.

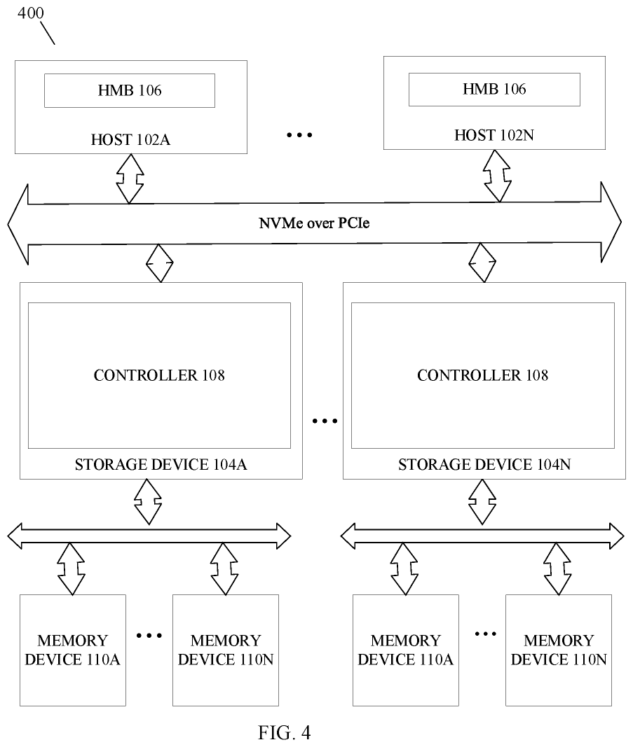

FIG. 4 is a diagram of an example environment in which systems and/or methods described herein are implemented. As shown in FIG. 4, Environment 400 may include hosts 102-102n (referred to herein as host(s) 102), and storage devices 104a-104n (referred to herein as storage device(s) 104).

Storage device 104 may include a controller 108 to manage the resources on storage device 104. Controller 108 may execute a power optimization module to manage the power consumption on storage device 104 and issue RAM usage policies based on the power consumption on storage device 104. Hosts 102 and storage devices 104 may communicate via a Non-Volatile Memory Express (NVMe) interface.

The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of Environment 400 may perform one or more functions described as being performed by another set of devices of Environment 400.

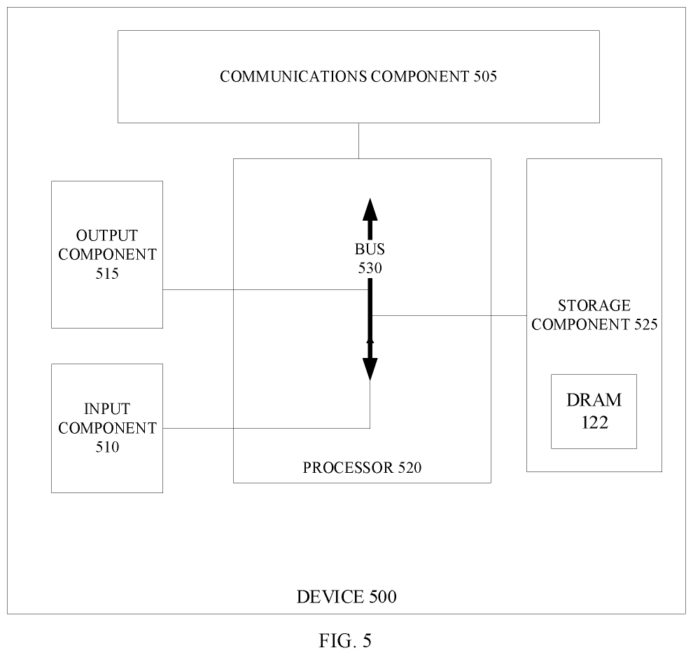

FIG. 5 is a diagram of example components of one or more devices of FIG. 1. In some implementations, host 102 may include one or more devices 500 and/or one or more components of device 500. Device 500 may include, for example, a communications component 505, an input component 510, an output component 515, a processor 520, a storage component 525, and a bus 530. Bus 530 may include components that enable communication among multiple components of device 500, wherein components of device 500 may be coupled to be in communication with other components of device 500 via bus 530.

Input component 510 may include components that permit device 500 to receive information via user input (e.g., keypad, a keyboard, a mouse, a pointing device, a microphone, and/or a display screen), and/or components that permit device 500 to determine the location or other sensor information (e.g., an accelerometer, a gyroscope, an actuator, another type of positional or environmental sensor). Output component 515 may include components that provide output information from device 500 (e.g., a speaker, display screen, and/or the like). Input component 510 and output component 515 may also be coupled to be in communication with processor 520.

Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 may include one or more processors capable of being programmed to perform a function. Processor 520 may be implemented in hardware, firmware, and/or a combination of hardware and software.

Storage component 525 may be, for example, storage device 104 that may include one or more memory devices, such as random-access memory (RAM), read-only memory (ROM), and/or another type of dynamic or static storage device (e.g., a flash memory, a magnetic memory, and/or optical memory) that stores information and/or instructions for use by processor 520. An example of RAM in storage component 525 may include DRAM 122. A memory device may include memory space within a single physical storage device or memory space spread across multiple physical storage devices. Storage component 525 may also store information and/or software related to the operation and use of device 500. For example, storage component 525 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, and/or another type of non-transitory computer-readable medium, along with a corresponding drive.

Communications component 505 may include a transceiver-like component that enables device 500 to communicate with other devices, such as via a wired connection, a wireless connection, or a combination of wired and wireless connections. The communications component 505 may permit device 500 to receive information from another device and/or provide information to another device. For example, communications component 505 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 505 may also include one or more broadband and/or narrowband transceivers and/or other similar types of wireless transceiver configurable to communicate via a wireless network for infrastructure communications. Communications component 505 may also include one or more local area network or personal area network transceivers, such as a Wi-Fi transceiver or a Bluetooth transceiver.

Device 500 may perform one or more processes described herein. For example, device 500 may perform these processes based on processor 520 executing software instructions stored by a non-transitory computer-readable medium, such as storage component 525. As used herein, the term “computer-readable medium” refers to a non-transitory memory device. Software instructions may be read into storage component 525 from another computer-readable medium or from another device via communications component 505. When executed, software instructions stored in storage component 525 may cause processor 520 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one of more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to optimize performance and operate under a predefined power ceiling, the storage device comprises:
a controller to receive an indication of a power mode under which the storage device is to operate from a host device; and
a power optimization module to determine power usage by the storage device, wherein when the power usage is below a power ceiling threshold, to issue a first random-access memory (RAM) usage policy for the controller to use an internal RAM in processing host data, and when the power usage is above the power ceiling threshold, to issue a second RAM usage policy for the controller to use one of an external RAM and the external RAM and portions of the internal RAM in processing the host data.

2. The storage device of claim 1, further comprising a host interface to receive commands from the host device and provide an indication of a host command to the power optimization module for use in determining the power mode which the storage device is to operate.

3. The storage device of claim 1, further comprising a flash translation layer (FTL) module to process backend operations and store FTL mappings according to a RAM usage policy issued by the power optimization module.

4. The storage device of claim 1, further comprising a traffic monitor to monitor traffic between the host device and the storage device and provide updates on traffic flow to the power optimization module for use in monitoring a congestion level on a link between the host device and the storage device.

5. The storage device of claim 1, further comprising a cache hit monitor to track how many pages are swapped in and out of the external RAM and provide an indication of a swap in/swap out rate to the power optimization module for use in monitoring the swap in/swap out rate on the external RAM.

6. The storage device of claim 1, wherein the power mode is associated with a power ceiling under which the storage device is to operate.

7. The storage device of claim 1, wherein the power mode is associated with a high-performance mode, wherein when the storage device is operating under the high-performance mode, the storage device disregards the power ceiling and operates according to the first RAM usage policy.

8. The storage device of claim 7, wherein the power optimization module determines that the storage device is operating under the high-performance mode based on one of a host command and an indication from an internal mechanism on the storage device.

9. The storage device of claim 1, wherein based on the second RAM usage policy the controller switches off banks in the internal RAM and uses the external RAM proportionately to meet a power target specification.

10. The storage device of claim 1, when one of the storage device receives a high-performance mode command from the host device, determines that the host device is operating in the high-performance mode, that there is a drop in cache hits on the external RAM, and that congestion on a link between the host device and the storage device is above a congestion threshold, the power optimization module issues the first RAM usage policy.

11. A method for optimizing performance on a storage device and operating under a predefined power ceiling, one or more processors on the storage device being configured to execute the method comprising:
receiving an indication of a power mode under which the storage device is to operate from a host device;
determining a power usage of the storage device; and
when the power usage is below a power ceiling threshold, issuing a first random-access memory (RAM) usage policy to use an internal RAM in processing host data, and
when the power usage is above the power ceiling threshold, issuing a second RAM usage policy to use one of an external RAM and the external RAM and portions of the internal RAM in processing the host data.

12. The method of claim 11, further comprising switching off banks in the internal RAM and using the external RAM proportionately to meet a power target specification based on the second RAM usage policy.

13. A method for optimizing performance on a storage device and operating under a predefined power ceiling, one or more processors on the storage device being configured to execute the method comprising:
receiving an indication of a power mode under which the storage device is to operate from a host device; and
determining a power usage of the storage device;
issuing a first random-access memory (RAM) usage policy to use an internal RAM in processing host data when the power usage is below a power ceiling threshold,
issuing a second RAM usage policy to use one of an external RAM and the external RAM and portions of the internal RAM in processing the host data when the power usage is above the power ceiling threshold; and
when operating under second RAM usage policy, one of receiving a high-performance mode command from the host device, determining that the host device is operating in the high-performance mode, determining that there is a drop in cache hits on the external RAM, and determining that a congestion level on a link between the host device and the storage device is above a congestion threshold, and issuing the first RAM usage policy to use the internal RAM in processing host data.

14. The method of claim 13, further comprising receiving commands from the host device and using an indication of a host command in determining the power mode which the storage device is to operate.

15. The method of claim 13, further comprising processing backend operations and storing mappings according to a RAM usage policy.

16. The method of claim 13, further comprising monitoring traffic between the host device and the storage device and using updates on traffic flow to monitor the congestion level on the link between the host device and the storage device.

17. The method of claim 13, further comprising tracking how many pages are swapped in and out of the external RAM and using an indication of a swap in/swap out rate to monitor the swap in/swap out rate on the external RAM.

18. The method of claim 13, wherein when the storage device is operating under the high-performance mode, the method further comprises disregarding the power ceiling and operating according to the first RAM usage policy.
